(19) United States
(12) Patent Application Publication
(10) Pub. No.: US 2013/0015212 A1
(43) Pub. Date: Jan. 17, 2013

(54) DISPENSING UNIT FOR LIQUID CONTAINERS

(71) Applicant: István S. Lindmayer, Dobrokoz (HU)

(72) Inventor: István S. Lindmayer, Dobrokoz (HU)

(73) Assignee: MAYEX CANADA KFT, Budapest (HU)

(21) Appl. No.: 13/516,303

(22) PCT Filed: Dec. 9, 2010
(86) PCT No.: PCT/HU10/00140

§ 371 Date: Aug. 6, 2012

(30) Foreign Application Priority Data
Dec. 16, 2009 (HU) P0900789

(51) Int. Cl. B65D 83/00

(52) U.S. Cl. 222/399; 222/518

(57) ABSTRACT

The dispensing unit for a liquid container comprises an enclosure (21), an operating lever (22) externally coupled to the enclosure and movable between a closing position and an opening position and provided with a resilient member to return said operating lever from its opening position into its closing position, a dispensing spout (23) projecting from the enclosure, first and second liquid dispensing channels (24, 25) formed within the enclosure and the dispensing spout, respectively. The resilient member is a leaf spring (35) formed integrally with the operating lever and arranged to bear against the external surface of said enclosure.

The present invention generally relates to a dispensing unit for liquid containers. More particularly, the present invention relates to a dispensing unit equipped with an anti-drip valve.

Nowadays, dispensing units that comprise a push-arm for dispensing a liquid typically stored in a pressurized container are well known and wide spread. A conventional dispensing unit, such as the dispensing head of a soda siphon, typically comprises at least an enclosure, a push-arm, a dispensing spout, a valve operated by said push-arm and liquid dispensing channels formed within said enclosure to connect the inner space of the liquid container with the dispensing orifice of the dispensing unit. In addition to these parts, a dispensing unit may further comprise a number of other elements within the enclosure or coupled externally thereto, such as a gas cartridge with an associated supporting element, a pressure regulator, a safety valve, etc. In such dispensing units, one of the liquid dispensing channels is usually closed inside the enclosure at a position relatively far from the orifice of the dispensing spout, therefore after dispensing, a small amount of liquid might remain within the spout, and this residual volume may leave the spout in the form of droplets after the dispensing has finished.

To eliminate this deficiency of the dispensing units, the U.S. Pat. No. 2,574,534 discloses a dispensing head for a pressurized liquid container, wherein an auxiliary valve is operated in the dispensing channel of the spout so as to prevent the liquid from dripping at the dispensing orifice after the use of the dispensing head. The construction of this dispensing head is rather complicated as it contains two separate valve assemblies, one for opening and closing the liquid container and another one for preventing dripping. Furthermore, both valve assemblies comprise a spiral spring as a resilient restoring member and several other additional minor parts. A further drawback of this dispensing unit is that after use, a residual liquid still remains in the passages inside the dispensing head, and such residual liquid, primarily in case of beverages, may deteriorate if the dispensing unit will not be used again for a long time. However, this dispensing unit cannot be disassembled for cleaning.

It is therefore an object of the present invention to eliminate the above drawbacks of the prior art solutions by providing a novel dispensing unit that has a simple design and that may also include a safety function without the addition of a separate safety valve.

It is another object of the present invention to provide a dispensing unit that is inexpensive to produce and therefore disposable, thus eliminating the need of cleaning the dispensing unit after use.

The above objects are achieved by providing a dispensing unit for a liquid container, said dispensing unit comprising an enclosure, an operating lever externally coupled to the enclosure and movable between a closing position and an opening position and provided with a resilient member to return said operating lever from its opening position into its closing position, a dispensing spout projecting from the enclosure, first and second liquid dispensing channels formed within the enclosure and the dispensing spout, respectively, and a valve adapted to open or sealingly close at least one of said first and second liquid dispensing channels, wherein said valve comprises a valve stem arranged in the liquid dispensing channel of the dispensing spout, said valve stem having a cross-sectional area that is smaller than the cross-sectional area of said second liquid dispensing channel, a valve head adapted to sealingly close an orifice at the external end of the second liquid dispensing channel of the dispensing spout, said valve head being coupled to the external end of said valve stem, and a valve supporting member coupled to the internal end of the valve stem and slidably guided in a guiding channel formed within said enclosure as an extension of the second liquid dispensing channel, said valve supporting member having a coupling portion presenting a forced coupling to the operating lever, and wherein said valve supporting member is adapted to seal said guiding channel in a gas-tight manner. The resilient member is a leaf spring formed integrally with the operating lever and arranged to bear against the external surface of said enclosure.

Preferred embodiments of the dispensing unit according to the present invention are defined by the dependent claims.

Due to the invention, a dispensing unit having a very simple structure is provided which is easy and inexpensive to manufacture and also disposable, while offering the usual convenient way to use. Furthermore, it has the advantage that no separate safety valve is required for the dispensing head since parts of the dispensing unit may be designed and dimensioned so that a single valve itself may be adapted to provide a safety function as well.

The invention will now be described in more detail with reference to the accompanying drawings, in which:

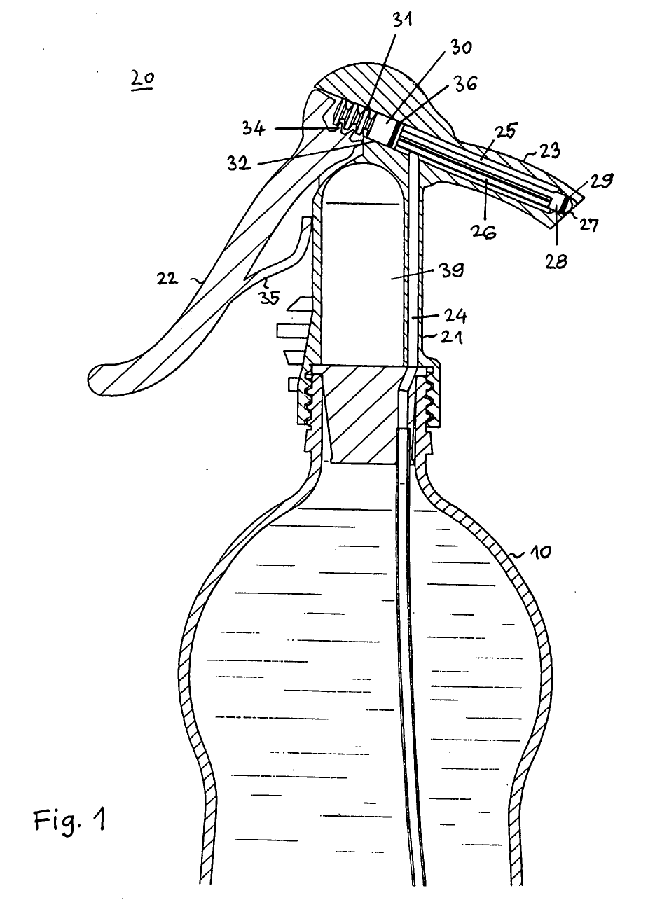

FIG. 1 is a cross-sectional view of the dispensing unit, according to a first preferred embodiment of the invention, in the closed state of the dispensing unit,

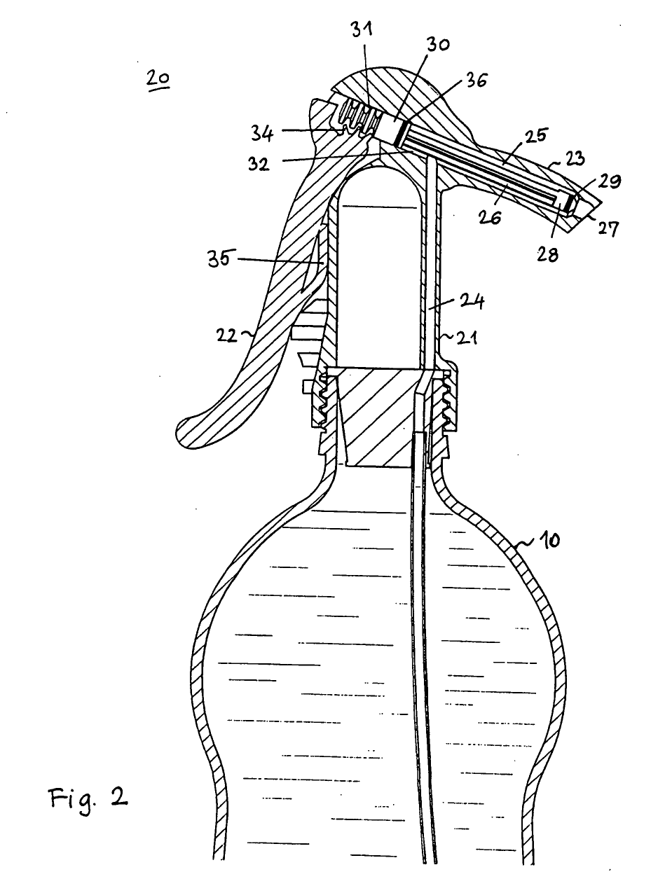

FIG. 2 a cross-sectional view of the dispensing unit, according to the first preferred embodiment of the invention, in the opened state of the dispensing unit, and

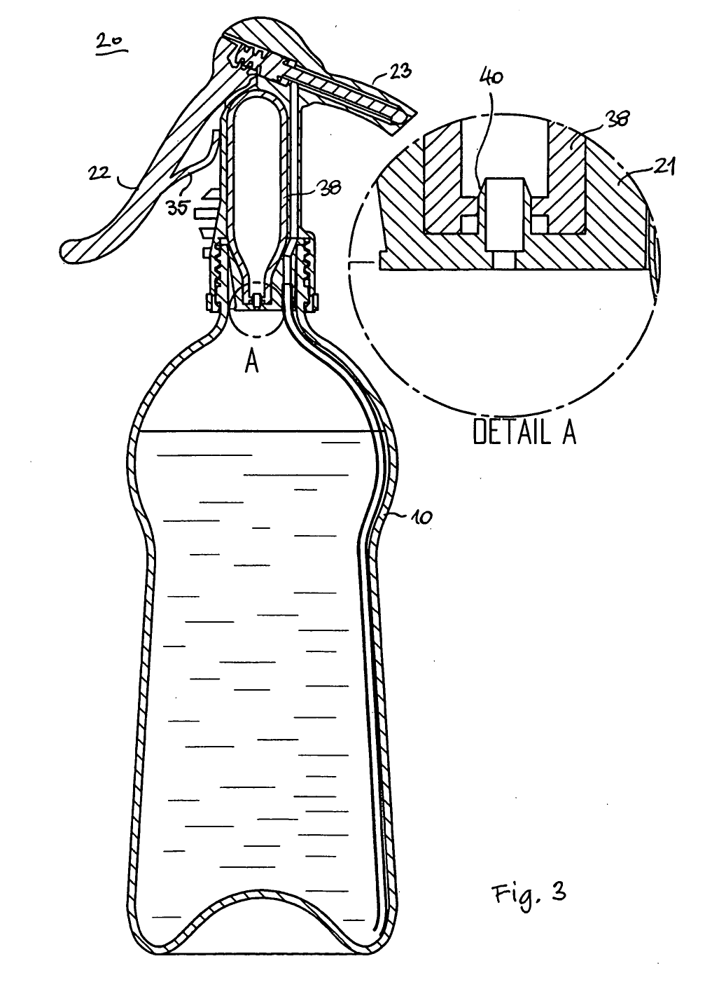

FIG. 3 is a cross-sectional view of the dispensing unit, according to a second preferred embodiment of the invention, in a closed state of the dispensing unit.

The first preferred embodiment of the dispensing unit according to the present invention will be described below with reference to FIGS. 1 and 2, which illustrate the cross-sectional views of the dispensing unit 20 according to the invention in its closed and opened states, respectively. The dispensing unit 20 comprises an enclosure 21, an operating lever 22 externally coupled to the enclosure 21 and movable between a closing position and an opening position, a dispensing spout 23 projecting from the enclosure 21, first and second liquid dispensing channels 24, 25 formed within the enclosure 21 and the dispensing spout 23, respectively, and a valve adapted to open or sealingly close at least one of the liquid dispensing channels 24 and 25. The operating lever 22 is hingedly coupled_{.} to the enclosure 21. The dispensing unit 20 is mounted on a liquid container 10, such as a beverage bottle, in a gas-tight manner.

The valve comprises a valve stem 26, a valve head 28 and a valve supporting member 30. The valve stem 26 is arranged in the liquid dispensing channel 25 of the dispensing spout 23. The cross-sectional area of the valve stem 26 is smaller than the cross-sectional area of the liquid dispensing channel 25, thus there is enough free. space for the liquid to flow out through the liquid dispensing channel 25 when being dispensed.

The valve head 28 is coupled to the external end of the valve stem 26 and adapted to sealingly close a dispensing orifice 27 at the external end of the liquid dispensing channel 25. To this end, it is preferred that the valve head 28 is equipped with a sealing ring 29, for example a rubber gasket, that provides a gas-tight seal for the liquid container at its orifice. At its internal end, the valve stem 26 is coupled to the valve supporting member 30 that has a coupling portion 31 presenting a forced coupling to the operating lever 22. At least a part of the valve supporting member 30 is slidably guided in a guiding channel 32 formed within the enclosure 21 as an extension of the liquid dispensing channel 25 of the dispensing spout 23. The valve supporting member 30 is also guided in a gas-tightly sealed manner in the guiding channel 32 so that the pressurized gas cannot escape from the pressurized liquid container at the valve supporting member 30. Preferably, the valve supporting member 30 is also equipped with a sealing ring 36, for example a rubber gasket.

As shown in FIGS. 1 and 2, at the end of the valve supporting member 30 opposite to the valve stem 26, the valve supporting member 30 is provided with grooves 37 adapted for engaging with teeth 34 formed on a corresponding coupling portion of the operating lever 22. Consequently, the valve can be moved forth and back in the dispensing spout 23 by means of the operating lever 22 through the forced coupling between the coupling portion 31 of the valve supporting member 30 and the corresponding coupling portion of the operating lever 22.

The dispensing unit 20 further comprises a leaf spring 35 to keep the operating lever 22 and thus the valve in their initial position, i.e. closing position, after dispensing, wherein said leaf spring 35 is integrally formed with the operating lever 22 and bears against the outer surface of the enclosure 21 of the dispensing unit 20.

It is particularly preferred that the enclosure 21, the operating lever 22 with the integrated leaf spring 35 and the complete valve are all made of plastic, thus the manufacturing cost of the dispensing unit can be further reduced and thus the whole dispensing unit is made disposable. Additionally, such a plastic dispensing unit may also be entirely recycled, which is another important feature of the present invention with regard to environment protection. Additionally, the use of plastic as the material of the whole dispensing unit, the manufacturing cost thereof becomes very low as compared to the prior art devices. In this preferred embodiment, wherein the valve is made of plastic, the sealing ring 29 of the valve head 28 and the sealing ring 36 of the valve supporting member 30 should also be made of plastic, and preferably those are formed as an integral part of the valve.

Now operation of the dispensing unit according to the invention will be described with reference to FIGS. 1 and 2. At dispensing, the operating lever 22 that is hingedly coupled to the enclosure 21 is moved from its closing position into its opening position, while the resilient leaf spring 35 of the dispensing unit 20 is pressed toward the enclosure 21. Through the rotation of the operating lever 22, the valve supporting member 30 and the valve head 28 at the external end of the valve stem 26 are moved together into an opening position, that is, the valve supporting member 30 is moved backward in the guiding channel 32, whereas the valve stem 26 and the valve head 28 are moved backward in the liquid dispensing channel 25, causing the dispensing orifice 27 of the dispensing spout 23 to be opened, through which the liquid can start to flow out due to the overpressure prevailing in the liquid container.

When the action of the force to the operating member 22 terminates, the resilient leaf spring 35 returns the operating lever 22 and the valve coupled thereto into their initial (closing) position, causing the valve head 28 at the external end of the valve stem 26 to sealigly close again the orifice 27 of the dispensing spout 23. As a consequence, outflow of the liquid from the container stops immediately, and since the valve head 28 accommodates substantially at the external end of the dispensing spout 23, post-dripping is not possible any longer after dispensing.

It is also particularly preferred that the diameter of the valve supporting member 30, the diameter of the valve head 28 and the spring constant of the leaf spring 35 is dimensioned so that when an overpressure exceeding a safety limit develops in the liquid container, the compressive force exerted by the gas of the container to the inner front surface of the valve supporting member 30 exceeds the sum of the force exerted by the leaf spring 35, which maintains the valve in its initial closing position, and the force exerted by the pressurizing gas to the inner front surface of the valve head 28, i.e. when the gas pressure in the liquid container 21 exceeds a safety pressure limit, the valve will open automatically and after the outflow of a certain amount of liquid from the container through the liquid channels 24, 25 and then the dispensing orifice 27, the pressure in the liquid container will drop below the safety pressure limit followed by an automatic closure of the valve. Thereafter no liquid can escape from the liquid container in its closed state. Thus the dispensing unit according to the invention may also provide an integrated safety valve function, and although the dangerous overpressure of the liquid container can be reduced by allowing some liquid to flow out from the container instead of releasing only some pressurizing gas, this issue has a minor significance with respect to the safe operation of the dispensing unit.

In FIG. 3, a second embodiment of the dispensing unit according to the invention is shown in a cross-sectional view in the closed state of the dispensing unit. In this embodiment, the enclosure 21 of the dispensing unit 20 incorporates a replaceable pressurizing gas cartridge 38 arranged in an internal chamber 39 (shown in FIG. 1), said gas cartridge 38 being adapted for attachment to the aperture of the liquid container in a conventional manner, for example by means of a hollow punch 40 adapted to perforate the seal of the gas cartridge at mounting. The gas cartridge may be made of steel or plastic, depending on the material and the initial pressure of gas used in the gas cartridge. When the gas cartridge 38, as well as other parts of the dispensing unit are all made of plastic, after the liquid container has become empty, the gas cartridge 38 may be removed, disposed and recycled together with the dispensing unit 20.

While the dispensing unit according to the present invention has been described with reference to certain embodiments thereof, it will be understood by those skilled in the art that several alternatives thereof involving the same inventive concept of the operation may be carried out without departing the scope of the invention defined by the appended claims.

1. A dispensing unit for a liquid container, said dispensing unit comprising;
an enclosure (21), an operating lever (22) externally coupled to the enclosure (21) and movable between a closing position and an opening position and provided with a resilient member to return said operating lever (22) from its opening position into its closing position, a dispensing spout (23) projecting from the enclosure (21), first and second liquid dispensing channels (24, 25) formed within the enclosure (21) and the dispensing spout (23), respectively, a valve adapted to open and sealingly close said second liquid dispensing channel (25), wherein said valve comprises
a valve stem (26) arranged in the liquid dispensing channel (25) of the dispensing spout (23), said valve stem (26) having a cross-sectional area that is smaller than the cross-sectional area of said second liquid dispensing channel (25),
a valve head (28) adapted to sealingly close an orifice (27) at the external end of the second liquid dispensing channel (25) of the dispensing spout (23), said valve head (28) being coupled to the external end of said valve stern (26), and
a valve supporting member (30) coupled to the internal end of the valve stem (26) and slidably guided in a guiding channel (32) formed within said enclosure (21) as an extension of the second liquid dispensing channel (25), said valve supporting member (30) having a coupling portion (31) presenting a forced coupling to the operating lever (22), and wherein said valve supporting member (30) is adapted to seal said guiding channel (25) in a gas-tight manner,
characterized in that
the resilient member is a leaf spring (35) formed integrally with the operating lever (22) and arranged to bear against the external surface of said enclosure (21) and
the valve supporting member (30), the valve head (28) and the spring constant of the leaf spring (35) are dimensioned so that when an overpressure exceeding a safety pressure limit develops in the liquid container (21), the force exerted by the pressurizing gas of the liquid container (21) to the inner front surface of the valve supporting member (30) exceeds the sum of the force exerted by the leaf spring (35) and the force exerted by the pressurizing gas to the inner front surface of the valve head (28), thus allowing the valve to open automatically.

2. The dispensing unit of claim 1, wherein said operating lever (22) with its integrated leaf spring (38), said enclosure and all parts of said valve are made of plastic.

3. The dispensing unit of claim 1, wherein the coupling portion (30) of the valve supporting member (30) is provided with grooves, whereas the operating member (22) is provided with teeth (34) engaging with said grooves of the coupling portion (31) of the valve supporting member (30).

4. (canceled)

5. The dispensing unit of 1 claim , wherein the enclosure (21) comprises a chamber (39) adapted to receive a pressurizing gas cartridge (38).
